(19) United States
(12) Patent Application Publication
(10) Pub. No.: US 2009/0247079 A1
(43) Pub. Date: Oct. 1, 2009

(54) TERMINAL OF RADIO-FREQUENCY TRANSMISSION/RECEPTION BY INDUCTIVE COUPLING

(75) Inventors: Alexandre Charles, Auriol (FR); Jerome Conraux, Trets (FR); Alexandre Malherbe, Trets (FR); Alexandre Tramoni, Saint Aygulf (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics (Rousset) SAS, Rousset (FR)

(21) Appl. No.: 12/413,222

(22) Filed: Mar. 27, 2009

(30) Foreign Application Priority Data
Mar. 31, 2008 (FR) 0852103

(51) Int. Cl. H04B 5/00

(52) U.S. Cl. 455/41.1

(57) ABSTRACT

A method and a device of transmission/reception by inductive coupling including circuitry for generating an AQ.C. signal intended to drive an oscillating circuit and circuitry intended to modulate the impedance of the oscillating circuit when data is to be transmitted, the oscillating circuit including an inductive element forming an antenna in parallel with a first capacitive element; and at least one second capacitive element in series with a switch, all in parallel with the first capacitive element and the antenna, the modulating circuitry being connected between the terminals of the antenna and the circuitry for generating the AQ.C. signal being connected to the junction point of the second capacitive element and of the switch.

### CROSS REFERENCE TO RELATED APPLICATIONS

This application claims the priority benefit of French patent application number 08/52103, filed on Mar. 31, 2008, entitled “TERMINAL OF RADIO-FREQUENCY TRANSMISSION/RECEPTION BY INDUCTIVE COUPLING,” which is hereby incorporated by. reference to the maximum extent allowable by law.

### BACKGROUND OF THE INVENTION

1. Field of the Invention

The present invention generally relates to the transmission of data by inductive coupling and, more specifically, to a contactless transceiver terminal capable of operating in a first so-called reader mode where the terminal communicates with a distant electromagnetic transponder, and a second so-called card mode where the terminal operates as an electromagnetic transponder with respect to another terminal.

2. Discussion of the Related Art

A contactless card reader transmits a magnetic field to an oscillating circuit of a card generally having no autonomous power supply. In the reader-to-card direction, the data are generally encoded, then transmitted in amplitude modulation of a carrier for driving an oscillating circuit of the reader. In the card (transponder)-to-reader direction, the card circuits modulate the load formed by the oscillating circuit of the card on the magnetic field of the reader, with a generally so-called retromodulation circuit, for example by short-circuiting the antenna circuit by means of a switch.

A radio-frequency terminal transmitting data by inductive coupling, capable of operating in card mode and in reader mode, needs to be able to manage the coding and the decoding of data frames according to different protocols.

Standards set the communication protocols. Reference can be made to ISO standard 14443 as an example, which defines that the antenna circuit of a reader is driven at a frequency on the order of 13.56 MHz. The data transmission in the reader-to-card direction is performed by amplitude modulation of the generated field with a modulation depth of 100% (ISO standard 14443-2/A) or of 10% (ISO standard 14443-2/B). In the card-to-reader direction, the data transmission is performed by modulation of the load at the rate of a sub-carrier at a frequency on the order of 847 kHz, this modulation being coded according to a Manchester type for standard 14443-2/A or to a BPSK type for standard 14443-2/B.

In card mode, the circuit supply is generally induced by the magnetic field generated by the reader which forms the communication channel between the card and the reader. The A.C. signal for driving the oscillating circuit of the reader then forms a remote-supply carrier for the card.

In reader mode, the terminal needs to be powered (by a battery or by a connection to the power line distribution system) to transmit the magnetic field to a card.

In dedicated devices, the reader antenna (or inductance of the oscillating circuit) is often adapted to the transmit frequency (for example, 13.56 MHz) and to the impedance of the A.C. signal generator, while the antenna (inductance of the resonant circuit) of a card is often tuned to the operating frequency of the system (for example, 13.56 MHz).

If the reader antenna is tuned, but mismatched, the transmission is not optimal. Further, the reflected wave linked to the mismatch disturbs the detection of the signal retromodulated by the card.

Conversely, if the card antenna is matched but off-tune, the power recovery is not optimized.

As a result, antenna circuits are generally not compatible for an operation in card mode and in reader mode. In particular, it is difficult to use a single antenna to design a device which can operate both in reader mode and in card mode.

Document EP-A-1327222 describes a contactless integrated circuit reader capable of operating in reader mode and in card mode, having its receive portion associated with inductive and capacitive low-pass and band-pass filters to allow an operation according to different protocols. Such operations can only be a matching in reader mode with no optimal tuning in card mode, or a tuning in card mode with no optimal matching in reader mode.

### SUMMARY OF THE INVENTION

It would be desirable to have a device capable of operating in reader mode and in card mode, which overcomes all or part of the disadvantages of usual devices.

More specifically, it would be desirable to have a device using a single antenna for an operation in card mode and in reader mode and which improves the matching in reader mode and the tuning in card mode.

It would also be desirable to have a solution requiring no further inductive element between the antenna and the demodulation circuits.

It would also be desirable to have a solution simplying switching from one mode to another.

It would also be desirable to improves the power consumption of the device, in particular when it operates in reader mode.

To achieve all or part of these objects as well as others, at least one embodiment of the present invention provides a device of transmission/reception by inductive coupling, comprising:

means for generating an AQ.C. signal intended to drive an oscillating circuit;

means intended to modulate the impedance of the oscillating circuit when data is to be transmitted, the oscillating circuit comprising:

an inductive element forming an antenna in parallel with a first capacitive element; and

at least one second capacitive element in series with a switch, all in parallel with the first capacitive element and the antenna, the modulation means being connected between the terminals of the antenna and the means for generating the AQ.C. signal being connected to the junction point of the second capacitive element and of the switch.

According to an embodiment, a third capacitive element, of same value as the second one, is connected in series with the second capacitive element and the switch, the switch connecting two electrodes of the second and third capacitive elements having their other electrodes connected to the respective electrodes of the first capacitive element, and two terminals of the means for providing the AQ.C. signal being respectively connected across the switch.

According to an embodiment, the switch is in an off position when the device is to transmit the AQ.C. signal and operate in reader mode.

According to an embodiment, the switch is in an on position when the device is to transmit data in load modulation and operate in card mode.

According to an embodiment, the capacitive elements are sized so that, at the frequency of the AQ.C. transmit signal, the oscillating circuit matches the output impedance of the means for generating the AQ.C. signal.

According to an embodiment, the sum of the values of the capacitive elements is selected so that the oscillating circuit is tuned to a frequency of an AQ.C. signal received from another device in card mode.

According to an embodiment, said switch is formed of an output switch of a transmit amplifier.

According to an embodiment, the device further comprises a second switch for disconnecting the modulation means when the device is to operate in reader mode.

The present invention also provides a method for configuring a device of transmission/reception by inductive coupling between an operation in reader mode and in card mode, comprising the step of switching capacitive elements of a single oscillating circuit of the device according to the operating mode.

According to an embodiment, the idle state of the device is in reader mode, the device switching to the card mode when it detects a supply voltage extracted from the oscillating circuit.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 very schematically illustrates a contactless data transmission system using a reader-card device;

FIG. 2 is a functional block of an embodiment of a reader-card device;

FIG. 2A shows the equivalent electric diagram of oscillating circuit 2 of FIG. 2 in reader mode;

FIG. 3 is a functional block diagram of another embodiment of a reader-card device;

FIGS. 4A and 4B illustrate two configurations of the oscillating circuit of the device of FIG. 3;

FIG. 5 is a more detailed block diagram of the reader-card device of FIG. 2;

FIG. 6 is a partial representation of a variation of the device of FIG. 5; and

FIG. 7 is an electric block diagram of still another embodiment of a reader-card device.

### DETAILED DESCRIPTION

The same elements have been designated with the same reference numerals in the different drawings. For clarity, only those elements which are useful to the understanding of the present invention have been shown and will be described. In particular, the data transmission protocols in reader mode or in card mode have not been detailed, the described embodiments being compatible with usual protocols which are generally standardized, and thus easily available. Further, the applications of the reader-card devices have not been detailed, the described embodiments being here again compatible with the different current uses of dual-mode or combined devices. For example, these may be terminals for communicating with electronic tags capable of switching to a card mode to transfer data from one terminal to a neighboring terminal down to a server. It may also be a portable device capable of operating according to applications in card mode (in a transport application) and in reader mode.

FIG. 1 is a block diagram of a system in which a device 1 is capable of communicating in reader mode with an electromagnetic transponder 8 (for example, a contactless chip card or an electronic tag) or in card mode with another reader 9, be it combined or not. The three devices 1, 8, and 9 comprise an inductive element L1, L8, L9 forming an antenna, associated with one or several capacitive elements (not shown in FIG. 1) to form an oscillating or resonant circuit of the concerned device. The other elements present in the blocks illustrated in FIG. 1 comprise the different data exploitation and transmission circuits.

For a card or tag 8, these circuits comprise at least one element for rectifying the signal sampled across the oscillating circuit to extract a supply voltage therefrom. The transponder also comprises retromodulation elements for modifying the load that it forms on the electromagnetic field generated by the reader and, possibly, circuits for demodulating data transmitted by the reader.

For a single reader 9, said reader comprises at least elements for generating an electromagnetic field for the transponders, capable of being amplitude-modulated to transmit data thereto, and elements for demodulating received data including means for detecting a load modulation performed by a transponder in the field.

Combined device 1 comprises both means for modulating an electromagnetic field that it generates and means for sensing an equivalent field and transmitting back retromodulated data.

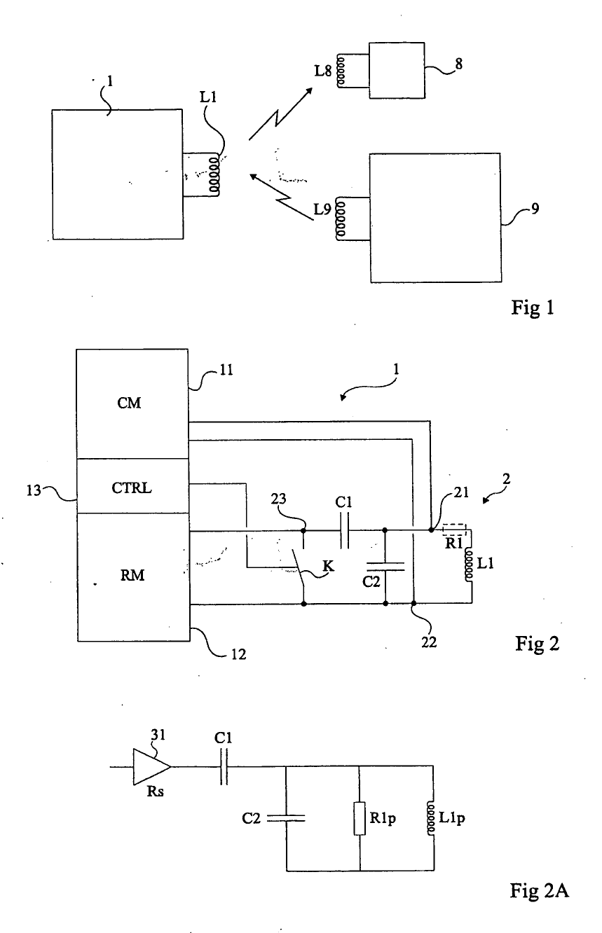

FIG. 2 is a block diagram of an embodiment of a combined device 1. This block diagram is functional in that the different elements used for the card mode and the reader mode have not been detailed and have been shown in separate blocks. In practice, some circuits may however be shared by both functions. Thus, a block 11 (CM) symbolizes the different circuits used in card mode, a block 12 (RM) symbolizes the different circuits used in reader mode, and a block 13 (CTRL) symbolizes the different circuits used to select the mode and synchronize the operation. In the example of FIG. 2, oscillating circuit 2 comprises, between terminals 21 and 22 of an antenna L1, a capacitive element C2 and a switchable capacitive element C1. The switching is performed, for example, by a switch K connected in series with capacitive element C1 across elements C2 and L1. The series (parasitic) resistance of the antenna has been illustrated in dotted lines by a resistive element R1. Terminals 21 and 22 are further connected to card mode block 11 to sample an AQ.C. signal sensed in the field of a reader. Junction point 23 of switch K and of capacitive element C1, as well as terminal 22, are connected to reader mode block 12 to drive oscillating circuit 2 with an AQ.C. signal when the device operates in reader mode.

Switch K is switched by control block 13 to an off position when the device is to operate in reader mode and to the on position when the device is to operate in card mode. Thus, in card mode, capacitive element C1 is in parallel on capacitive element C2 and their respective values add to each other. In reader mode, switch K is off and capacitance C1 takes part in the impedance matching circuit at the frequency of the carrier driving the oscillating circuit (for example, 13.56 MHz).

Consider an output stage (not shown) of block 12 exhibiting an output impedance Rs. In practice, the output impedances of the amplifiers of the reader mode are smaller than some ten ohms and thus do not match, at the operating frequency of the device, the impedance of the antenna. This requires an impedance matching scheme.

The matching in read mode comprises using a so-called “L” topology with two elements. Given the values of the elements to be matched, both elements are capacitive (C1 and C2).

FIG. 2A illustrates the equivalent electric diagram of circuit 2 of FIG. 2 in reader mode with resistor R1 brought in parallel (noted R1p) on the inductance (noted L1p). FIG. 2A illustrates the presence of an output amplifier 31 (buffer) of block 12. Such an amplifier 31 is of three-state type to exhibit, in card mode, a high-impedance state at its output.

To pass from the parallel equivalent model (FIG. 2A) to the series equivalent model (FIG. 2) and conversely, the following relations are currently used (to simplify the notations, reference is made to L1, R1, L1p and R1p to designate the values of the involved elements):

$$Q = \frac{Xs}{R 1} = \frac{L 1 \cdot ω}{R 1} ,$$

where Xs represents the series admittance of output amplifier 31 and Q represents the quality factor of series circuit L1-R1.

R1p=(Q²+1)·R1; and

$$L 1 p = \frac{{X}_{L 1 p}}{ω} = \frac{R 1 p}{ω \cdot Q} ,$$

where X_{L1p} represents the admittance of inductance L1.

In card mode, the sum of capacitances C1 and C2 need to be such that the oscillating circuit has the frequency of the field emitted by a distant terminal as a resonance frequency.

In reader mode, the matching is obtained in an “L” topology of elements C1 and C2 as illustrated in FIG. 2A. Considering that the resistance per unit length of the antenna placed in parallel is high (typically on the order of a few kilo-ohms), capacitances C1 and C2 are selected so that the quality factors of the parallel and series elements Qp and Qs of the matching are equal and can be written as:

$$Qs = Qp = \sqrt{\frac{R 1 p}{Rs} - 1} .$$

The components of oscillating circuit 2 are thus sized according to the tuning and matching frequencies. Preferably, the values of capacitors C1 and C2 are determined based on the impedance matching needs in reader mode, knowing the value of the inductance of the antenna. Generally, this inductance value of the antenna is linked to its geometry.

Taking into account the above-disclosed conditions, the values of elements C1 and C2 may be determined as follows:

$$C 1 = \frac{1}{ω \cdot \sqrt{Rs \cdot ( R 1 p - Rs )}} ;$$

$$and$$

$$C 2 = \frac{R 1 p \cdot \sqrt{\frac{Rs}{R 1 p - Rs}} - ω \cdot L 1 p}{R 1 p \cdot \sqrt{\frac{Rs}{R 1 p Rs}} \cdot {ω}^{2} \cdot L 1 p} , \\ or$$

$$C 2 = \frac{R 1 p - ω \cdot L 1 p \cdot \sqrt{\frac{R 1 p}{Rs} - 1}}{{ω}^{2} \cdot R 1 p \cdot L 1 p} .$$

The value given to capacitance C2 needs not only take into account the above elements (for example, be calculated by the above relation), but also take into account the input capacitance of the device, that is, the capacitance connected to the oscillating circuit. For example, if the elements of the device connected to oscillating circuit 2 provide a 20-pF capacitance, the value of capacitance C2 obtained by the above relation is decreased by 20 pF. The value of capacitance C1 is unmodified.

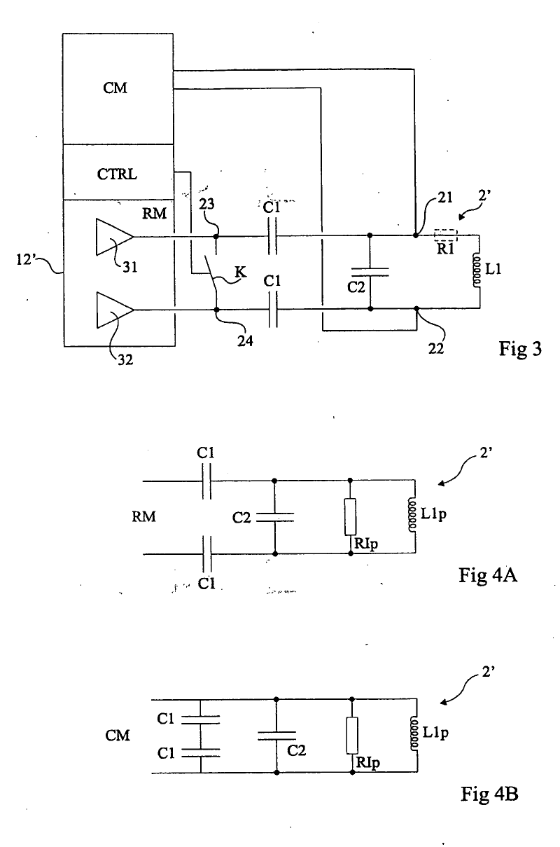

FIG. 3 illustrates another embodiment in which the circuits of the reader mode comprise two output amplifiers 31 and 32 respectively connected by identical capacitive elements C1 to terminal 21 and to terminal 22. Switch K connects the respective outputs 23 and 24 of amplifiers 31 and 32. The card side of the circuit is not modified. Output amplifiers or buffers 31 and 32 are, in card mode, switched to a state where their output is in high impedance so as not to interfere with the reception. As compared with the previous embodiment, the difference is linked to the dual amplifier output topology of block 12′, which requires a symmetrical matching structure.

FIG. 4A illustrates the equivalent electric diagram of oscillating circuit 2′ of FIG. 3 when switch K is off (reader mode).

FIG. 4B illustrates the equivalent electric diagram of oscillating circuit 2′ of FIG. 3 when switch K is on (card mode).

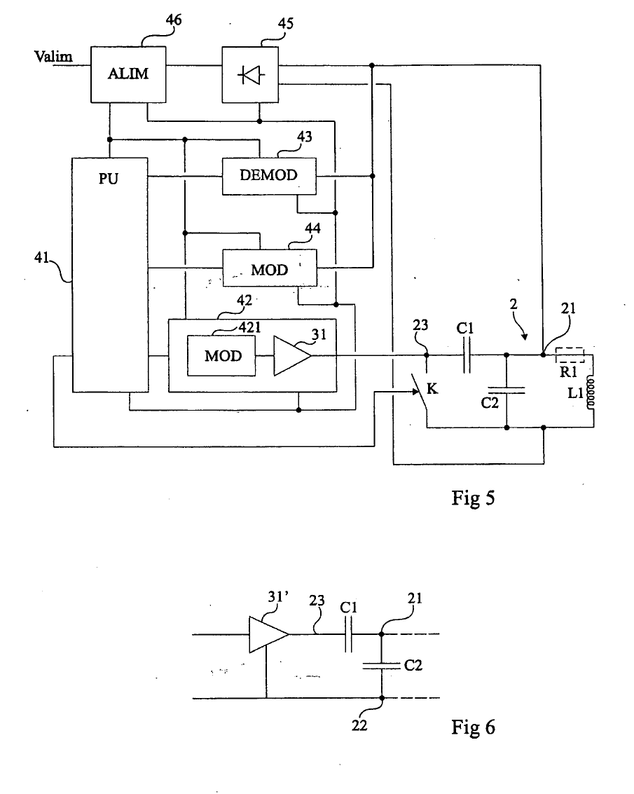

FIG. 5 is a more detailed block diagram of a device capable of operating both in card mode and in reader mode using an oscillating circuit 2 such as illustrated in FIG. 2.

A processing unit 41 (PU) is used to exploit the data to be transmitted and the received data. In reader mode, unit 41 controls a transmit circuit 42 comprising, among others, a modulator 421 (MOD) and an output amplifier or buffer 31 capable of being switched to high impedance.

In card mode, unit 41 receives data extracted from oscillating circuit 2 via a demodulator 43 (DEMOD) and can modulate the load formed on the oscillating circuit by means of a modulator 44 (MOD). In this operating mode, the device supply may be extracted from the high-frequency field radiated by the distant terminal by means of a rectifying element 45 (for example, a rectifying bridge) having its inputs connected to terminals 21 and 22 of the oscillating circuit and having its outputs connected to a supply circuit 46 (ALIM). Circuit 46 is, for example, a voltage regulator providing the voltages to the different circuits 41, 42, 43, 44 of the device.

In reader mode, regulator 46 for example receives a supply voltage Valim from a battery of the electric distribution network.

FIG. 6 illustrates a variation according to which switch K is one with output amplifier 31′ of the card mode. Such amplifiers are indeed most often made in the form of MOS transistors. The MOS transistor, typically with an N channel, of the low portion of the output amplifier can then be used to ground terminal 23.

Such an arrangement may also be envisaged in the embodiment of FIG. 3 due to the respective low and high transistors of the output transistor pairs of amplifiers 31 and 32.

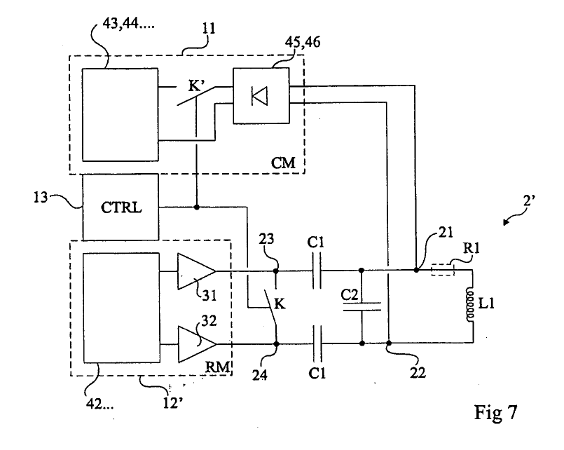

FIG. 7 shows another embodiment having the structure of that of FIG. 3 but in which an additional switch K′ disconnects the circuits of the card mode when the device is to operate in reader mode. In practice, the supply circuits (rectifier 45 and circuit 46) preferably remain connected, that is, switch K′ is coupled between these circuits and the rest of the card mode circuits (at least circuits 43 and 44, FIG. 5). In a simplified embodiment, control circuit 13 triggering the turning-on of switch K also triggers that of switch K′.

For example, in the idle state, switches K and K′ are off and the device is supposed to operate in reader mode. For the case where a supply voltage is detected at the level of rectifier 45, even with a matched and non-tuned circuit, the recovered voltage is sufficient for circuit 13 to turn on switches K and K′ and to switch to the card mode.

According to an alternative embodiment of switch K′, the switch may be integrated in voltage regulator 46 to form a controlled regulator.

It is now possible to share a single antenna (a single inductive winding) for a device capable of operating in reader mode and in card mode. The provided system is particularly simple. On this regard, advantage is taken from the parallel-series structure of the oscillating circuits of the readers and cards of the systems to which the embodiments apply. In particular, conversely to π- or T-type structures, the specific arrangement of the capacitive and inductive elements of the oscillating circuits enables an L matching resulting in a tuned circuit in card mode.

As a specific embodiment, a device intended to operate according to one of the 14443 standards with a 13.56-MHz frequency may be formed with an antenna having a 1-μH inductance and capacitive elements C1 and C2 which, in the embodiment of FIGS. 3 and 7, have a cumulated 138-pF value. Considering that the equivalent resistance in parallel of the inductive element (impedance of the antenna) is of a few kilo-ohms (for example, on the order of 3 kΩ) while the output resistance of the amplifiers of the reader mode is of a few ohms (for example, on the order of 4 ohms), the distribution between values C1 and C2 performed according to the matching calculation in reader mode at 13.56 MHz is, in this example, 107 pF for C1 and 31 pF for C2. If the circuits to which oscillating circuit 2 is connected provide a capacitance on the order of 20 pF, the value given to capacitance C2 is now no more than 11 pF (31-20).

Various embodiments of the present invention have been described. Different variations and modifications are within the abilities of those skilled in the art. In particular, the selection of the values to be given to the capacitive elements according to the used antenna is within the abilities of those skilled in the art based on the functional indications given hereabove and on the matching and tuning frequencies respectively intended for the reader mode and for the card mode. Further, although the present invention has been more specifically described in relation with an example applied to standards 14443, it more generally applies to any radio-frequency transceiver system in which a device is capable of operating in reader mode and in card mode.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A device of transmission/reception by inductive coupling comprising:
means for generating an AQ.C. signal intended to drive an oscillating circuit;
means intended to modulate the impedance of the oscillating circuit when data is to be transmitted,
wherein the oscillating circuit comprises:
an inductive element forming an antenna in parallel with a first capacitive element; and
at least one second capacitive element in series with a switch, all in parallel with the first capacitive element and the antenna, the modulation means being connected between the terminals of the antenna and the means for generating the AQ.C. signal being connected to the junction point of the second capacitive element and of the switch.

2. The device of claim 1, wherein a third capacitive element, of same value as the second one, is connected in series with the second capacitive element and the switch, the switch connecting two electrodes of the second and third capacitive elements having their other electrodes connected to the respective electrodes of the first capacitive element, and two terminals of the means for providing the AQ.C. signal being respectively connected across the switch.

3. The device of claim 1, wherein the switch (K) is in off position when the device must transmit the AQ.C. signal and operate in reader mode.

4. The device of any of claims 1, wherein the switch is in an on position when the device is to transmit data in load modulation and operate in card mode.

5. The device of claim 1, wherein the capacitive elements are sized so that, at the frequency of the AQ.C. transmit signal, the oscillating circuit matches an output impedance of the means for generating the AQ.C. signal.

6. The device of claim 1, wherein the sum of the values of the capacitive elements is selected so that the oscillating circuit is tuned to a frequency of an AQ.C. signal received from another device in card mode.

7. The device of claim 1, wherein said switch is formed of an output switch of a transmit amplifier.

8. The device of claim 1, further comprising a second switch for disconnecting the modulation means when the device is to operate in reader mode.

9. A method for configuring a device of transmission/reception by inductive coupling between an operation in reader mode and in card mode, comprising the step of switching capacitive elements of a single oscillating circuit of the device according to an operating mode.

10. The method of claim 9, wherein an idle state of the device is in reader mode, the device switching to the card mode when it detects a supply voltage extracted from the oscillating circuit.
